(19) United States
(12) Patent Application Publication
(10) Pub. No.: US 2023/0099231 A1
(43) Pub. Date: Mar. 30, 2023

(54) POWER STORAGE DEVICE

(71) Applicant: Prime Planet Energy & Solutions, Inc., Tokyo (JP)

(72) Inventor: Akira KATAYAMA, Himeji-shi (JP)

(21) Appl. No.: 17/935,132

(22) Filed: Sep. 26, 2022

(30) Foreign Application Priority Data
Sep. 27, 2021 (JP) 2021-156474

(51) Int. Cl. H01M 50/209; H01M 50/30

(52) U.S. Cl. CPC H01M 50/209; H01M 50/30

(57) ABSTRACT

A power storage device includes: a plurality of power storage cells; and a case having an inner space in which the plurality of power storage cells are accommodated, and an outer surface that defines the inner space. The outer surface of the case includes a pleated portion that is capable of becoming elongated in response to an increase in pressure of the inner space. The pleated portion is formed on substantially an entire periphery of the case along a peripheral direction of the case.

This nonprovisional application is based on Japanese Patent Application No. 2021-156474 filed on Sep. 27, 2021, with the Japan Patent Office, the entire contents of which are hereby incorporated by reference.

### BACKGROUND OF THE INVENTION

### Field of the Invention

The present technology relates to a power storage device.

### Description of the Background Art

Japanese Patent Laying-Open No. 2009-146812 illustrates that a pleated portion is provided on a side surface of a battery case on the side on which a safety valve is provided and the pleated portion becomes elongated to allow gas to flow to the safety valve side when an internal pressure of the battery case is increased, thereby improving gas discharging efficiency.

When a temperature in the case of the power storage device is increased, it may be required to increase an amount of heat radiation from a surface of the case in order to suppress further temperature increase. In view of the above, the conventional power storage device does not necessarily have a sufficient configuration.

### SUMMARY OF THE INVENTION

An object of the present technology is to provide a power storage device to suppress an increase in temperature in a case of the power storage device.

An power storage device according to the present technology includes: a plurality of power storage cells; and a case having an inner space in which the plurality of power storage cells are accommodated, and an outer surface that defines the inner space. The outer surface of the case includes a pleated portion that is capable of becoming elongated in response to an increase in pressure of the inner space. The pleated portion is formed on substantially an entire periphery of the case along a peripheral direction of the case.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing an external appearance of a battery pack.

FIG. 2 is a perspective view showing a battery cell in the battery pack.

FIG. 3 is a diagram schematically showing a portion corresponding to an A-A cross section of the case shown in FIG. 1.

FIG. 4 is a diagram schematically showing a state in which the case is expanded from the state shown in FIG. 3.

FIG. 5 is a diagram schematically showing a pleated portion provided in the case.

FIG. 6 is a diagram showing a state in which the pleated portion is elongated from the state shown in FIG. 5.

FIG. 7 is a cross sectional view showing a detail of the pleated portion.

FIG. 8 is a diagram schematically showing a modification of the pleated portion provided in the case.

### DESCRIPTION OF THE PREFERRED EMBODIMENTS

Hereinafter, embodiments of the present technology will be described. It should be noted that the same or corresponding portions are denoted by the same reference characters, and may not be described repeatedly.

It should be noted that in the embodiments described below, when reference is made to number, amount, and the like, the scope of the present technology is not necessarily limited to the number, amount, and the like unless otherwise stated particularly. Further, in the embodiments described below, each component is not necessarily essential to the present technology unless otherwise stated particularly. Further, the present technology is not limited to one that necessarily exhibits all the functions and effects stated in the present embodiment.

It should be noted that in the present specification, the terms “comprise”, “include”, and “have” are open-end terms. That is, when a certain configuration is included, a configuration other than the foregoing configuration may or may not be included.

Also, in the present specification, when geometric terms and terms representing positional/directional relations are used, for example, when terms such as “parallel”, “orthogonal”, “obliquely at 45°”, “coaxial”, and “along” are used, these terms permit manufacturing errors or slight fluctuations. In the present specification, when terms representing relative positional relations such as “upper side” and “lower side” are used, each of these terms is used to indicate a relative positional relation in one state, and the relative positional relation may be reversed or turned at any angle in accordance with an installation direction of each mechanism (for example, the entire mechanism is reversed upside down).

In the present specification, the term “battery” is not limited to a lithium ion battery, and may include another battery such as a nickel-metal hydride battery.

In the present specification, when the terms “power storage cell” or “power storage module” are used, the “power storage cell” or the “power storage module” is not limited to a battery cell or a battery module, and may include a capacitor cell or a capacitor module.

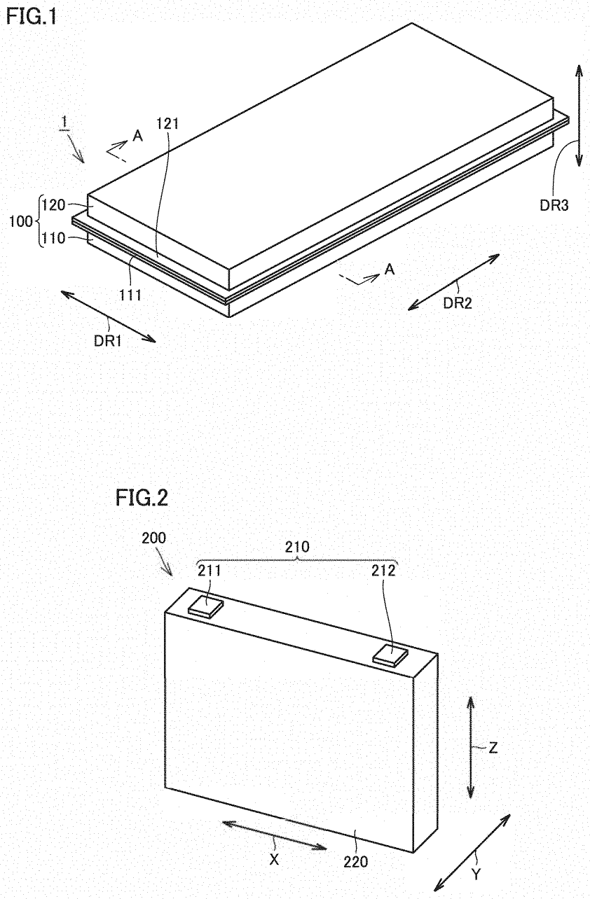

FIG. 1 is a perspective view showing an external appearance of a battery pack 1 (power storage device). As shown in FIG. 1, battery pack 1 has a case 100. Case 100 has: a main body member 110 (first member) including a first flange 111; and a cover member 120 (second member) including a second flange 121 joined to first flange 111. A plurality of battery cells are accommodated in a space formed inside main body member 110 and cover member 120. The plurality of battery cells may be stacked in a direction of arrow DR1 or in a direction of arrow DR2.

FIG. 2 is a diagram showing a battery cell 200 accommodated in case 100. As shown in FIG. 2, battery cell 200 is formed to have a substantially rectangular parallelepiped shape with a flat surface. It should be noted that the battery cell of the present technology is not limited to such a battery cell having a prismatic shape and includes a different type of battery cell such as a battery cell having a substantially cylindrical shape.

Battery cell 200 includes an electrode terminal 210 and a battery case 220. Electrode terminal 210 includes a positive electrode terminal 211 and a negative electrode terminal 212. Positive electrode terminal 211 and negative electrode terminal 212 are arranged side by side in an X axis direction. Electrode terminal 210 is provided on the upper surface of battery case 220. Each of the upper surface and bottom surface of battery case 220 has a substantially rectangular shape in which the X axis direction corresponds to a long side direction and a Y axis direction corresponds to a short side direction. An electrode assembly and an electrolyte solution are accommodated in battery case 220. Battery cells 200 are stacked in the Y axis direction.

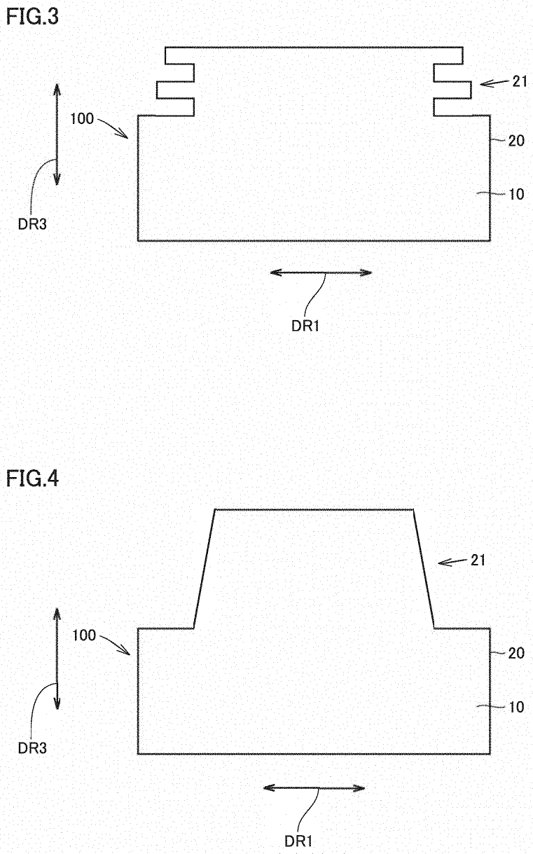

FIG. 3 is a diagram schematically showing a portion corresponding to an A-A cross section of case 100 shown in FIG. 1. FIG. 4 is a diagram schematically showing a state in which case 100 is expanded from the state shown in FIG. 3.

As shown in FIG. 3, case 100 has an inner space 10 in which the plurality of battery cells 200 are accommodated, and an outer surface 20 that defines inner space 10.

When a battery cell 200 in case 100 exhibits thermal runaway, the temperature and pressure of inner space 10 are increased. In battery pack 1 according to the present embodiment, outer surface 20 of case 100 includes a pleated portion 21 that can become elongated in response to an increase in pressure of inner space 10. Pleated portion 21 is formed on substantially an entire periphery of case 100 along a peripheral direction of case 100 (the direction of arrow DR1 and the direction of arrow DR2). The expression “substantially the entire periphery” herein is not necessarily limited to the case where pleated portion 21 is continuously formed on the entire periphery in the peripheral direction, and may include a case where pleated portion 21 is discontinuously formed on the entire periphery in the peripheral direction, and a case where pleated portion 21 is formed on almost the entire periphery in the peripheral direction but is not formed partially thereon.

When the pressure of inner space 10 is increased to become more than or equal to a predetermined value, pleated portion 21 becomes elongated in a direction (direction of arrow DR3) intersecting the peripheral direction of case 100 as shown in FIG. 4. Thus, the volume of inner space 10 and the surface area of outer surface 20 are increased. With the increased volume of inner space 10, an increase in internal pressure is reduced. Further, the increased surface area of outer surface 20 leads to improved efficiency of heat radiation from case 100. As a result, damage of battery pack 1 is suppressed.

As an example, a ratio of increase of inner space 10 due to the elongation of pleated portion 21 is about more than or equal to 0.1% and less than or equal to 100%, but the scope of the present technology is not limited thereto.

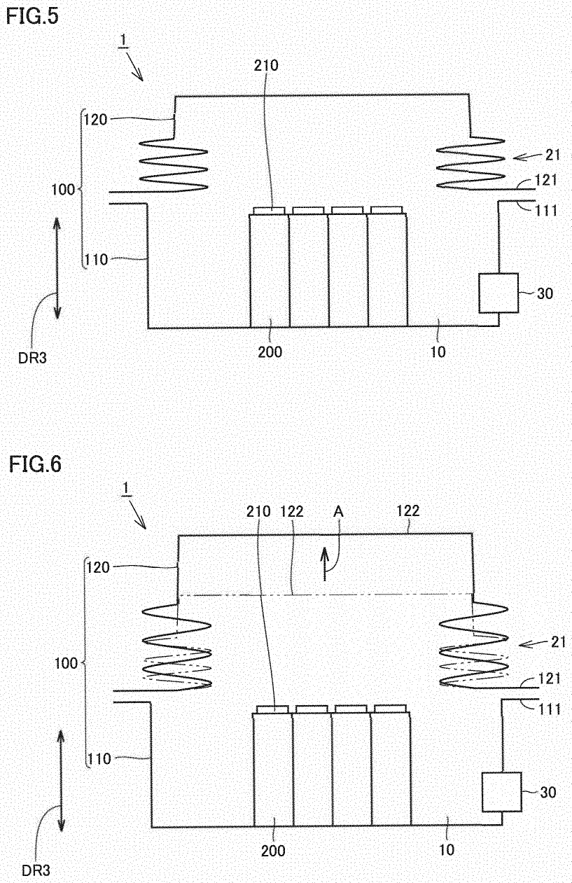

As an example, the ratio of increase of the surface area of case 100 due to the elongation of pleated portion 21 is about more than or equal to 0.1% and less than or equal to 100%, but the scope of the present technology is not limited thereto. FIG. 5 is a diagram schematically showing pleated portion 21 provided in case 100. FIG. 6 is a diagram showing a state in which pleated portion 21 is elongated from the state shown in FIG. 5.

In the example of FIGS. 5 and 6, pleated portion 21 is formed in cover member 120 facing electrode terminals 210. Pleated portion 21 is formed to extend in a direction (direction of arrow DR3) intersecting the extending direction of each of first flange 111 and second flange 121 when pleated portion 21 is in an non-elongated state. In the example of FIGS. 5 and 6, pleated portion 21 is formed at a position adjacent to second flange 121, but the scope of the present technology is not limited thereto.

Case 100 includes a safety valve 30 that brings inner space 10 into communication with outside of case 100 when the pressure of inner space 10 becomes more than or equal to a predetermined operation pressure (first pressure: about 0.2 MPa, for example). Pleated portion 21 is formed to become elongated when the pressure of inner space 10 becomes more than or equal to a predetermined operation pressure (second pressure: 0.18 MPa, for example) smaller than the operation pressure (first pressure) of safety valve 30. When pleated portion 21 is operated by an increased pressure of inner space 10 due to thermal runaway of a battery cell 200, upper surface 122 of cover member 120 is moved (raised) in a direction of separating away from battery cell 200 along the direction of arrow DR3 as shown in FIG. 6. Inner space 10 is increased according to an amount of elongation of pleated portion 21. The surface area of outer surface 20 is also increased according to the amount of elongation of pleated portion 21.

By setting the operation pressure (second pressure) of pleated portion 21 to be smaller than the operation pressure (first pressure) of safety valve 30, pleated portion 21 can be operated to increase the volume of inner space 10 and the surface area of outer surface 20 before safety valve 30 is operated to discharge the gas inside case 100 to the outside of case 100, thereby suppressing an increase in temperature of battery pack 1. When the pressure of inner space 10 continues to be increased even after the operation of pleated portion 21 and reaches the operation pressure of safety valve 30, safety valve 30 is opened to discharge the gas inside inner space 10 to the outside of case 100.

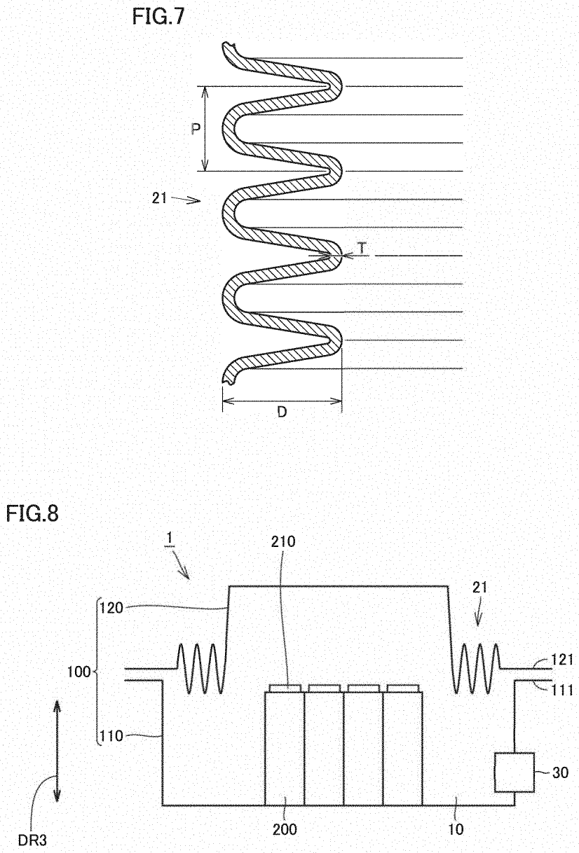

FIG. 7 is a cross sectional view showing a detail of pleated portion 21. As shown in FIG. 7, pleated portion 21 is formed to have certain pitch (P), depth (D), and thickness (T), but these can be changed as appropriate. The pitch (P) of pleated portion 21 is, for example, about ¼ of the thickness of cover member 120. The depth of pleated portion 21 is, for example, about ½ of the protruding width of each of first flange 111 and second flange 121. The thickness (T) of pleated portion 21 is, for example, substantially the same as the thickness of cover member 120. The length of pleated portion 21 (size in the upward/downward direction in FIG. 7) can also be changed as appropriate.

FIG. 8 is a diagram schematically showing a modification of pleated portion 21. In the example of FIG. 8, as with the example of FIGS. 5 and 6, pleated portion 21 is formed in cover member 120 facing electrode terminals 210. On the other hand, in the example shown in FIG. 8, unlike the example shown in FIGS. 5 and 6, pleated portion 21 is formed to extend in a direction (the direction of arrow DR1 and the direction of arrow DR2) along the extending direction of each of first flange 111 and second flange 121 when pleated portion 21 is in a non-elongated state.

In the above-described examples, it has been illustratively described that pleated portion 21 is formed in cover member 120; however, the scope of the present technology is not limited thereto, and pleated portion 21 may be formed in main body member 110.

Although the embodiments of the present invention have been described and illustrated in detail, it is clearly understood that the same is by way of illustration and example only and is not to be taken by way of limitation, the scope of the present invention being interpreted by the terms of the appended claims. The scope of the present invention is defined by the terms of the claims, and is intended to include any modifications within the scope and meaning equivalent to the terms of the claims.

What is claimed is:

1. A power storage device comprising:
a plurality of power storage cells; and
a case having an inner space in which the plurality of power storage cells are accommodated, and an outer surface that defines the inner space, wherein
the outer surface of the case includes a pleated portion that is capable of becoming elongated in response to an increase in pressure of the inner space, and
the pleated portion is formed on substantially an entire periphery of the case along a peripheral direction of the case.

2. The power storage device according to claim 1, wherein
each of the plurality of power storage cells includes an electrode terminal,
the case includes a cover member in the outer surface, the cover member facing the electrode terminal, and
the pleated portion is formed in the cover member.

3. The power storage device according to claim 1, wherein
the case has a first member including a first flange and a second member including a second flange joined to the first flange, and
the pleated portion is formed in one of the first member and the second member so as to extend in a direction intersecting an extending direction of each of the first flange and the second flange when the pleated portion is in a non-elongated state.

4. The power storage device according to claim 1, wherein
the case has a first member including a first flange and a second member including a second flange joined to the first flange, and
the pleated portion is formed in one of the first member and the second member so as to extend in a direction along an extending direction of each of the first flange and the second flange when the pleated portion is in a non-elongated state.

5. The power storage device according to claim 1, wherein
the case has a safety valve that brings the inner space into communication with outside of the case when the pressure of the inner space becomes more than or equal to a first pressure, and
the pleated portion is formed to become elongated when the pressure of the inner space becomes more than or equal to a second pressure smaller than the first pressure.

6. The power storage device according to claim 1, wherein a ratio of increase of the inner space due to the elongation of the pleated portion is more than or equal to 0.1% and less than or equal to 100%.

7. The power storage device according to claim 1, wherein a ratio of increase of a surface area of the case due to the elongation of the pleated portion is more than or equal to 0.1% and less than or equal to 100%.
